(19) United States
(12) Patent Application Publication
(10) Pub. No.: US 2008/0100772 A1
(43) Pub. Date: May 1, 2008

(54) Reflective Light Source Device and Manufacture Method Thereof

(75) Inventors: Po-Iem Lin, Hsin-Chu (TW); Yu-Chuan Lin, Hsin-Chu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORPORATION, Hsin-Chu (TW)

(21) Appl. No.: 11/928,225

(22) Filed: Oct. 30, 2007

(30) Foreign Application Priority Data
Nov. 1, 2006 (TW) 95140420

(51) Int. Cl. F21V 7/04; G02F 1/1335; H01J 9/00

(52) U.S. Cl. 349/61; 362/612; 445/29

(57) ABSTRACT

The present invention provides a backlight module and a light source device used therein. The present invention also provides the light source device manufacturing method. The light source device comprises a circuit substrate, light-emitting elements and a solder-resist reflective layer. The circuit substrate has a metal circuit layer and contacts thereon. The light-emitting elements are arranged in the form of arrays on the circuit substrate and are connected to the contacts. One end of each contact is connected to the metal circuit layer, and the other end is connected to the light-emitting element. The solder-resist reflective layer is formed on the circuit substrate and is disposed on the same side as the light-emitting elements. The solder-resist reflective layer covers the metal circuit layer but exposes the contacts.

### BACKGROUND OF THE INVENTION

1. Field of the Invention

The present invention relates generally to a backlight module and a light source device used therein, and more particularly to a backlight module and a light source device for a liquid crystal display (LCD) device.

2. Description of the Prior Art

Backlight modules are employed extensively in LCD devices, computer keyboards, cell phone buttons, billboards and other devices requiring light sources to provide the necessary flat light sources. Especially, the recent market demand for LCD devices has considerably increased. In order to accord with functional and external appearance requirements in LCD devices, the backlight module design for a LCD device has gradually become multidimensional.

Due to various electronic products using LCD devices have progressed in design trend towards light, thin and compact products, the demand for volume reduction of LCD devices has become strict accordingly. Aiming to this design requirement, the light source module occupying more volume in the backlight module undergoes corresponding design adjustment. Generally speaking, the mainstream of light source modules includes the light source designs of lamp tube and of LED, and the design using LED as the light source meets the requirement for volume reduction relatively closer.

FIG. 1 shows a conventional light source device using LED. As shown in FIG. 1, the light source device comprises a substrate 31 and contacts 35 disposed thereon. LED elements 33 are connected onto the contacts 35. In order to protect copper wire on the substrate 31, a layer of solder-resist green paint 50 is coated onto the substrate 31. Since the solder-resist green paint 50 has a poorer light reflectivity, part of light produced by the LED elements 33 is absorbed directly or indirectly by the solder-resist green paint 50, and further affects the utilization rate of the produced light.

In order to enhance the utilization rate of light emitting out of the LED elements 33, conventionally, a high-reflectance reflection sheet is adhered to the solder-resist green paint 50. Reflection sheets usually have complex geometric design thereon. However, such design of additional reflection sheet adhesion often creates difficult assembly, an increased cost and labor hours. Moreover, since assembling requires high precision and complex design on the reflection sheet, such method causes a reduced product yield.

### SUMMARY OF THE INVENTION

It is a main object of the present invention to provide a light source device for a backlight module having both functions of solder resistance and of light reflection.

It is another object of the present invention to provide a backlight module and a light source device used therein having a simplified production process.

It is still another object of the present invention to provide a backlight module and a light source device used therein reducing the production cost.

It is a further object of the present invention to provide a light source device manufacturing method simplifying the overall production process.

It is yet another object of the invention to provide a light source device manufacturing method reducing the overall production time.

The backlight module of the present invention comprises a frame, a light guide plate and a light source device. The light source device is disposed corresponding to the entrance surface of the light guide plate. The light source device comprises a circuit substrate, light-emitting elements and a solder-resist reflective layer. The circuit substrate has a metal circuit layer and contacts thereon; the light-emitting elements are arranged in the form of arrays on the circuit substrate and are connected to the contacts. One end of each contact is connected to the metal circuit layer and the other end is connected to the light-emitting element. The light-emitting elements are preferably electroluminescence elements, such as LED, etc.

The solder-resist reflective layer is formed on the circuit substrate and is disposed on the same side as the light-emitting elements. The solder-resist reflective layer covers the metal circuit layer but exposes the contacts. The wavelength of reflective spectrum of the solder-resist reflective layer ranges between 380 nm and 780 nm. Through disposing the solder-resist reflective layer, the light source device enhances the utilization rate of light produced by the light-emitting elements to provide more desirable overall light output efficiency. In order to enhance the reflectance of the solder-resist reflective layer, the solder-resist reflective layer preferably includes a white or other colors having preferable reflectance upper surface.

The solder-resist reflective layer is made of mixture having a solder-resist material and a reflective material. The solder-resist material is preferably made of a thermosetting resin, a photosensitive material or other curing materials, such as an epoxy resin, acrylic ester, etc. The reflective material changes light reflection characteristic after mixing with the solder-resist material, and the change methods include changing color of the solder-resist reflective layer after mixing, and creating a higher percentage of light-reflective particles in the mixture. The reflective material preferably includes the following materials: barium sulfate, titanium oxide, boron nitride or aluminum oxide.

The light source device manufacturing method first comprises preparing a circuit substrate having contacts; then forming a solder-resist reflective layer on the circuit substrate and exposing the contacts. The solder-resist reflective layer forming step comprises the following steps: mixing the solder-resist material and the reflective material to create the solder-resist reflective material; distributing the solder-resist reflective material on the circuit substrate; and curing the solder-resist reflective material distributed on the circuit substrate to form the solder-resist reflective layer. This method includes a final step of disposing the light-emitting elements on the contacts.

### BRIEF DESCRIPTION OF THE DRAWINGS

FIG. 1 is a cross-sectional view of a conventional light source device containing LED.

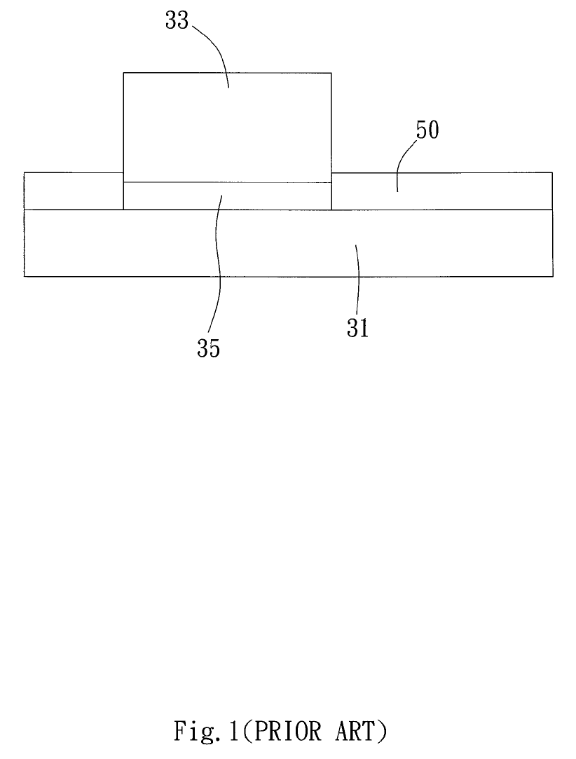

FIG. 2 is an exploded view of one embodiment of the backlight module in accordance with the present invention.

FIG. 3 is a schematic diagram of one embodiment of the light source device in accordance with the present invention.

FIG. 4 is a cross-sectional view of the embodiment shown in FIG. 3.

FIG. 5 is a flow chart of one embodiment of the light source device manufacturing method in accordance with the present invention.

FIG. 6 is a flow chart of another embodiment of the light source device manufacturing method.

### DETAILED DESCRIPTION OF THE PREFERRED EMBODIMENT

The present invention provides a backlight module and a light source device used therein. The present invention further provides the light source device manufacturing method. For the preferred embodiment, the backlight module is used in a liquid crystal display (LCD) device. However, in other embodiments, the backlight module may be used in computer keyboards, cell phone buttons, billboards or other devices requiring flat light sources. Moreover, the present invention further includes a LCD device using the backlight module. In the preferred embodiments, the LCD device in accordance with the present invention includes a color LCD device. However, in other embodiments, the LCD device in accordance with the present invention may include a monochromatic LCD device. The LCD device refers generally to display devices using liquid crystal panels, including household liquid crystal television (LCTV), LC monitors of personal computers and laptops, LC display screen of cell phones and digital cameras.

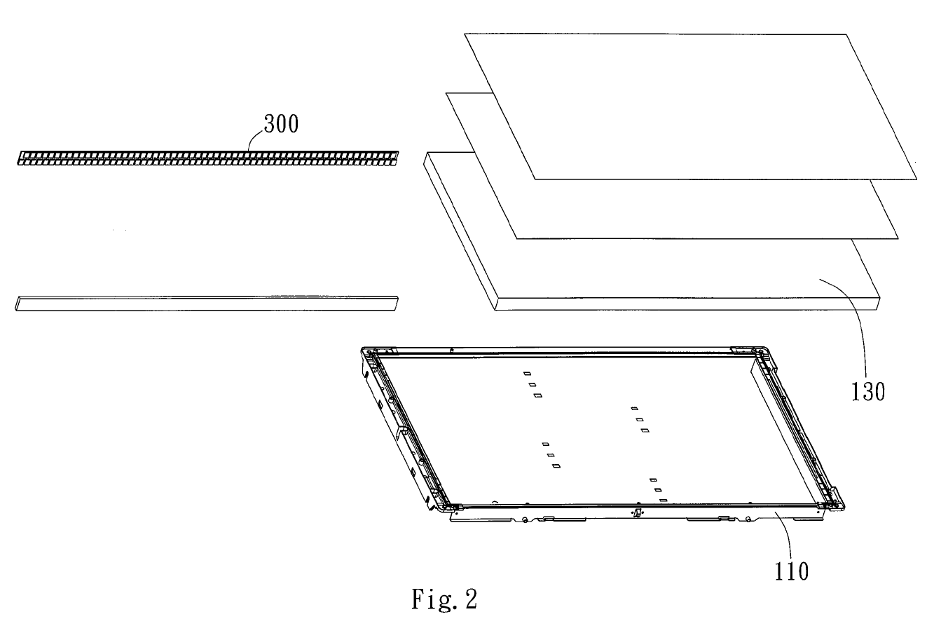

As shown in FIG. 2, the backlight module according to the present invention comprises a frame 110, a light guide plate 130 and a light source device 300. The frame 110 is disposed on the outside of the light guide plate 130, and the light source device 300 is disposed corresponding to the light entrance surface of the light guide plate 130. In this embodiment, the light source device 300 is disposed on the side of the light guide plate 130; however, in other embodiments, the light source device 300 may be disposed under the light guide plate 130 to form a direct type backlight module. Light produced by the light source device 300 are incident into the light guide plate 130, and the light guide plate 130 uniforms the light through the inner structure thereof to produce more uniform backlight.

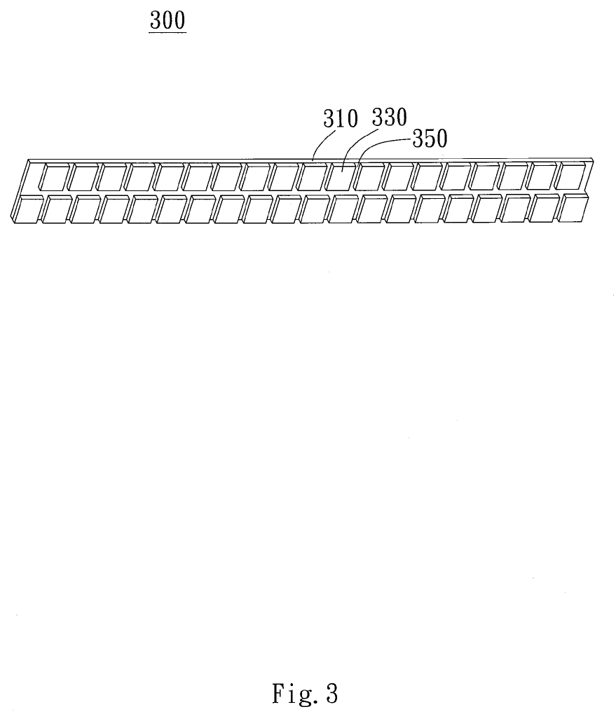

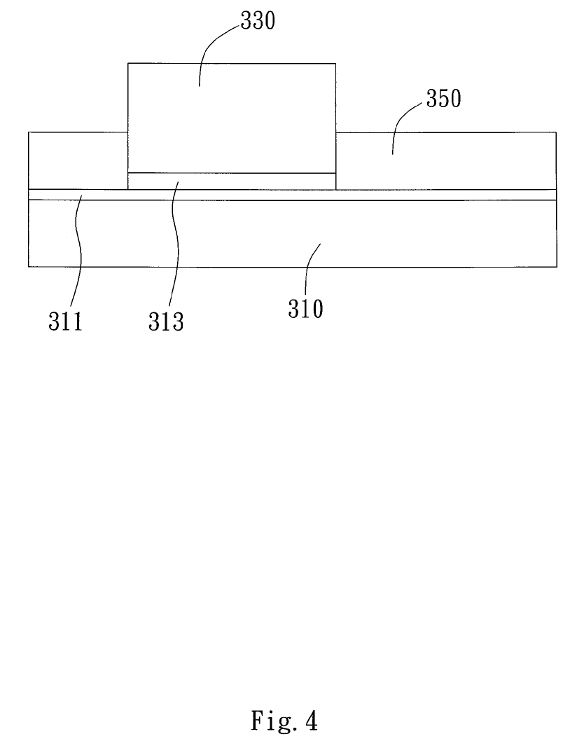

The light source device 300 comprises a circuit substrate 310, light-emitting elements 330 and a solder-resist reflective layer 350. The circuit substrate 310 may include printed circuit board (PCB), flexible printed circuit and other types of circuits. As shown in FIG. 3 and FIG. 4, the circuit substrate 310 includes a metal circuit layer 311 and contacts 313 thereon. In the preferred embodiment, the metal circuit layer 311 is formed on the circuit substrate 310 by a copper foil etching process; however, in other embodiments, the metal circuit layer 311 may be formed on the circuit substrate 310 by employing processes such as adhesion, printing, etc. For a design aspect of the metal circuit layer 311, the circuit substrate 310 includes various forms such as a single-sided plate, a double-sided plate, a double-layer plate, etc. Moreover, the circuit substrate 310 is preferably made of bakelite, semi-glass fiberboard, all-glass fiberboard, teflon board, polyimide (PI), polyester fiber, or other similar materials.

In the preferred embodiment, as shown in FIG. 3, the light-emitting elements 330 are arranged in the form of arrays on the circuit substrate 310. The light-emitting elements 330 include electroluminescence elements such as LED, etc. The contacts 313 are for connecting the light-emitting elements 330. As shown in FIG. 4, one end of each contact 313 is connected to the metal circuit layer 311, and the other end is connected to the light-emitting element 330. The light-emitting elements 330 is connected onto the contacts 313 preferably by surface mount technology (SMT); however, in other embodiments, the light-emitting element 330 may be connected to the contacts 313 by through hole technology (THT).

The solder-resist reflective layer 350 is formed on the circuit substrate 310 and is disposed on the same side as the light-emitting elements 330. Moreover, the solder-resist reflective layer 350 is preferably connected to the edges of the light-emitting elements. As shown in FIG. 3 and FIG. 4, the solder-resist reflective layer 350 covers the metal circuit layer 311 but exposes the contacts 313; in other words, the solder-resist reflective layer 350 is distributed between the contacts 313. Besides, the solder-resist reflective layer 350 does not cover the light-emitting elements 330.

In the preferred embodiment, the wavelength of reflective spectrum of the solder-resist reflective layer 350 ranges between 380 nm and 780 nm. In other words, the solder-resist reflective layer 350 achieves high-reflectance effect for light wavelength within this interval. In addition, the solder-resist reflective layer 350 preferably provides over 95% reflectivity for the incident light having wavelength between 380 nm and 780 nm. Through disposing the solder-resist reflective layer, the light source device enhances the utilization rate of light produced by the light-emitting elements 330 to provide more desirable overall light output efficiency. In order to enhance the reflectance of the solder-resist reflective layer 350, the solder-resist reflective layer 350 preferably includes a white or other colors having preferable reflectance upper surface.

In the preferred embodiment, the solder-resist reflective layer 350 is made of mixture having a solder-resist material and a reflective material. The solder-resist material is preferably made of a thermosetting resin, such as an epoxy resin, etc.; however, in other embodiments, the solder-resist material may be made of a photosensitive material, such as an acrylic ester, or of other curing materials. The reflective material changes the light reflection characteristic after mixing with the solder-resist material, and the change methods include changing color of the solder-resist reflective layer 350 after mixing, and creating a higher percentage of light-reflective particles in the mixture. The reflective material preferably includes the following materials: barium sulfate, titanium oxide, boron nitride or aluminum oxide. In addition, the reflective material may be made of the combinations of the above materials. By combining the properties of the solder-resist material and the reflective material, the solder-resist reflective layer 350 possesses both the solder resistance function for protecting the circuit substrate 310 and the light reflection function for enhancing light utilization rate of the light-emitting elements 330.

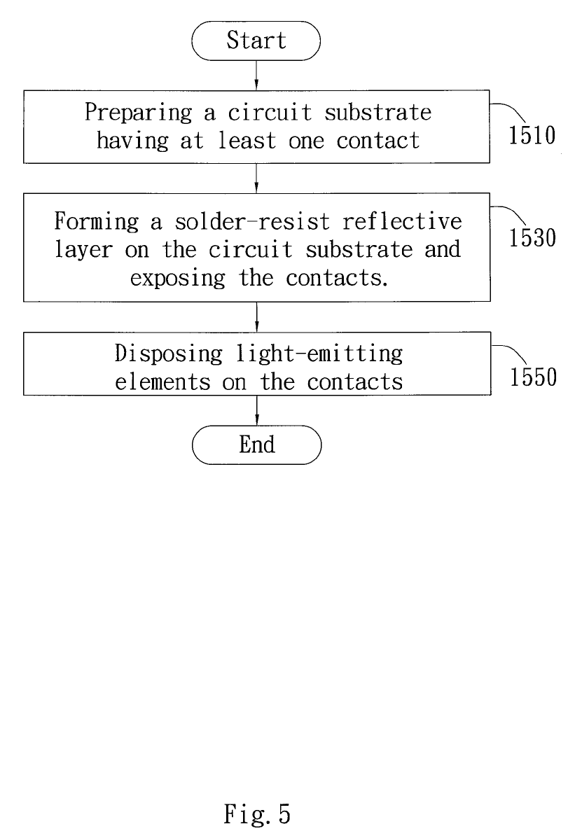

FIG. 5 shows a flow chart of one embodiment of the light source device 300 manufacturing method in accordance with the present invention. As shown in FIG. 5, the light source device 300 manufacturing method first comprises a step 1510: preparing the circuit substrate 310 having the contacts 313 thereon. In the preferred embodiment, the circuit substrate 310 can be made of bakelite, semi-glass fiberboard, all-glass fiberboard, teflon board, polyimide (PI), polyester fiber or other similar materials. Furthermore, this step preferably includes performing a copper foil circuit etching process on the circuit substrate 310 to create the metal circuit layer 311 and to form the contacts 313. However, in other embodiments, the metal circuit layer 311 may be formed on the circuit substrate 310 by employing processes such as adhesion, printing, etc.

The step 1530 comprises forming the solder-resist reflective layer 350 on the circuit substrate 310, and exposing the contacts 313. In the preferred embodiment, the solder-resist reflective material is distributed on the circuit substrate 310 in this step, but the contacts 313 are exposed to form the solder-resist reflective layer 350. The wavelength of reflective spectrum of the solder-resist reflective material preferably ranges between 380 nm and 780 nm; in other words, in the preferred embodiment, the solder-resist reflective layer made of the solder-resist reflective materials achieves high-reflectance effect for light wavelength within this interval.

The step 1550 comprises disposing light-emitting elements 330 on the contacts 313. In the preferred embodiment, the light-emitting elements 330 are connected onto the contacts 313 by surface mount technology (SMT); however, in other embodiments, the light-emitting elements 330 may be connected to the contacts 313 by through hole technology (THT). Moreover, in the preferred embodiment, the light-emitting elements 330 include electroluminescence elements, such as LED, etc.

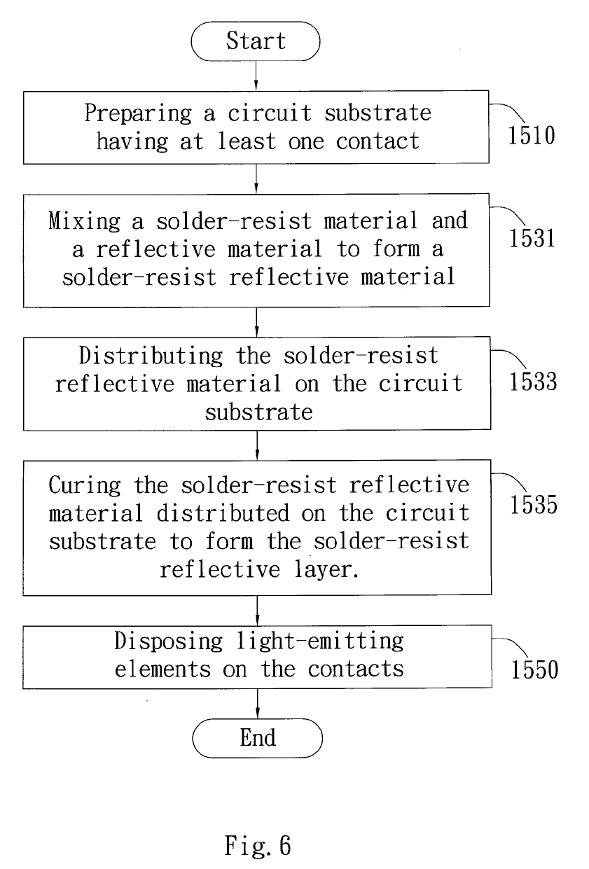

As shown in FIG. 6, the solder-resist reflective layer 350 forming step further comprises a step 1531: mixing the solder-resist material and the reflective material to form the solder-resist reflective material. In the preferred embodiment, this step requires adjusting the ratio of the solder-resist material to the reflective material to make the reflectance of the mixed solder-resist reflective material greater than 95% for visible light having wavelength between 380 nm and 780 nm. The solder-resist material is preferably made of a thermosetting resin, such as an epoxy resin, etc.; however, in other embodiments, the solder-resist material may be made of a photosensitive material, such as an acrylic ester, or of other curing materials. The reflective material changes the light reflection characteristic after mixing with the solder-resist material, and the change methods include changing color of the solder-resist reflective layer 350 after mixing, and creating a higher percentage of light-reflective particles in the mixture. The reflective material preferably includes the following materials: barium sulfate, titanium oxide, boron nitride or aluminum oxide. In addition, the reflective material may be made of the combinations of the above materials. By combining the properties of the solder-resist material and the reflective material, the solder-resist reflective layer 350 possesses both the solder resistance function for protecting the circuit substrate 310 and the light reflection function for enhancing light utilization rate of the light-emitting elements 330.

The step 1533 comprises distributing the solder-resist reflective material on the circuit substrate 310. In the preferred embodiment, the solder-resist reflective material is distributed on the circuit substrate 310 by an ink process. The ink process preferably includes the methods of printing, coating, sputtering, etc. to distribute the solder-resist reflective material. The step 1535 comprises curing the solder-resist reflective material distributed on the circuit substrate 310 to form the solder-resist reflective layer 350. In the preferred embodiment, the solder-resist reflective material on the circuit substrate 310 is cured by a baking process. In this embodiment, the solder-resist reflective material needs to include thermosetting materials therein, such as an epoxy resin. However, in other embodiments, the solder-resist reflective material on the circuit substrate 310 may be cured by a development process. In this instance, the solder-resist reflective material needs to include photosensitive materials therein, such as an acrylic ester.

From the foregoing, it shall be appreciated that specific embodiments of the invention have been described herein for purposes of illustration, but that various modifications and alterations may be made by those skilled in the art without deviating from the spirit and scope of the invention. For example, it shall be understood that there is no intention to limit the invention to the specific forms disclosed, but on the contrary, the invention is to cover all modifications, alternate constructions and equivalents falling within the spirit and scope of the invention. Accordingly, the invention is not limited except as by the appended claims.

What is claimed is:

1. A light source device comprising:
a circuit substrate having two or more contacts;
at least one light-emitting element being electrically connected to said contact; and
a solder-resist reflective layer formed on said circuit substrate and disposed on the same side as said light-emitting element, said solder-resist reflective layer is distributed between said contacts.

2. The light source device of claim 1, wherein the wavelength of reflective spectrum of said solder-resist reflective layer ranges between 380 nm (nanometer) and 780 nm.

3. The light source device of claim 2, wherein said solder-resist reflective layer has a reflectance over 95% for visible light having wavelength between 380 nm and 780 nm.

4. The light source device of claim 1, wherein said light-emitting element includes a light emitting diode (LED).

5. The light source device of claim 1, wherein said solder-resist reflective layer is made of mixture having a solder-resist material and a reflective material.

6. The light source device of claim 5, wherein said solder-resist material includes a thermosetting resin.

7. The light source device of claim 5, wherein said solder-resist material includes an acrylic ester.

8. The light source device of claim 5, wherein said reflective material is selected from the group of barium sulfate, titanium oxide, boron nitride, aluminum oxide and the combination thereof.

9. The light source device of claim 1, wherein said solder-resist reflective layer has a white upper surface.

10. A light source device manufacturing method comprising the following steps:
preparing a circuit substrate having at least one contact;
forming a solder-resist reflective layer on said circuit substrate and exposing said contact; and
disposing a light-emitting element on said contact.

11. The light source device manufacturing method of claim 10, wherein said circuit substrate preparing step includes copper foil circuit etching.

12. The light source device manufacturing method of claim 10, wherein said solder-resist reflective layer forming step includes the following steps:
mixing a solder-resist material and a reflective material to create a solder-resist reflective material; and
distributing said solder-resist reflective material over said circuit substrate to form said solder-resist reflective layer.

13. The light source device manufacturing method of claim 12, wherein said solder-resist reflective material distributing step includes coating, printing, or sputtering said solder-resist reflective material onto said circuit substrate.

14. The light source device manufacturing method of claim 12 further comprising a development process performed on said solder-resist reflective material distributed over said circuit substrate.

15. The light source device manufacturing method of claim 12 further comprising a baking process performed on said solder-resist reflective material distributed over said circuit substrate.

16. The light source device manufacturing method of claim 12, wherein said solder-resist reflective materials mixing step includes adjusting the ratio of said solder-resist material to said reflective material to make the reflectance of said mixed solder-resist reflective material greater than 95% for visible light having wavelength between 380 nm and 780 nm.

17. The light source device manufacturing method of claim 12, wherein said solder-resist material is selected from the group of epoxy resin, acrylic ester and the combination thereof.

18. The light source device manufacturing method of claim 12, wherein said reflective material is selected from the group of barium sulfate, titanium oxide, boron nitride, aluminum oxide and the combination thereof.

19. The light source manufacturing method of claim 10, wherein said light-emitting element disposing step includes performing a surface mount process to connect said light-emitting element onto said contact.

20. A backlight module for a liquid crystal display device containing a light source device as claimed in claim 1.
